(19) United States
(12) Patent Application Publication
(10) Pub. No.: US 2025/0245485 A1
(43) Pub. Date: Jul. 31, 2025

(54) USER INSIGHTS USING DEEP GENERATIVE FOUNDATION MODELS

(71) Applicant: ADOBE INC., SAN JOSE, CA (US)

(72) Inventors: Suofei Wu, Fremont, CA (US); Hsiang-Yu Yang, Palo Alto, CA (US); Luwan Zhang, Sunnyvale, CA (US); Zeyu Jin, Santa Clara, CA (US)

(21) Appl. No.: 18/426,848

(22) Filed: Jan. 30, 2024

(51) Int. Cl. G06N 3/0455; G06F 40/284; G06N 3/08

(52) U.S. Cl. CPC G06N 3/0455; G06F 40/284; G06N 3/08

(57) ABSTRACT

Systems and methods for generating user insights include obtaining a query about a user interaction with a software application. The query can be in the form of a natural language question. Embodiments then select a task from a plurality of event prediction tasks based on the query. Next, embodiments generate, using a machine learning model, an event prediction based on the query and the task, where the machine learning model is trained to predict an event based on a sequence of user interactions with the software application. Embodiments then generate a natural language response to the query based on the task and the event prediction.

### BACKGROUND

The following relates generally to data analysis, and more specifically to generating data insights using foundational generative models. Data analysis is a technology field that includes techniques and processes used to inspect, cleanse, transform, and model data with the goal of discovering useful information, informing conclusions, and supporting decision-making. At its core, data analysis is the systematic application of statistical and logical techniques to describe, summarize, and compare data. Techniques range from basic data aggregation and summarization to more complex statistical methods and algorithms. In recent years, the integration of machine learning and artificial intelligence has expanded the capabilities of data analysis, allowing for more sophisticated and predictive forms of data evaluation.

Generative models are a specific application of machine learning (ML) techniques, and are designed to generate new data instances that resemble a given data distribution. These models are useful in scenarios where data generation or simulation is required, such as in image and speech synthesis, pharmaceutical compound discovery, and content generation. Some generative models are employed for sequence-to-sequence tasks, and can be used to predict future data points based on observed sequences. This involves learning the underlying structure and patterns within the data to produce plausible and coherent sequences.

### SUMMARY

Embodiments include systems and methods for generating insights about data from natural language queries. An insight apparatus obtains a query via a user interface. An input agent of the insight apparatus parses and interprets the query to determine one or more tasks included in the query, as well as conditions related to the task(s). Examples of task(s) include functions on data related to predictions, analysis, and insights. Examples of data include sequence data, such as historical user interactions with a software application. A machine learning model of the insight apparatus receives the task(s) and conditions and, using a core model trained to perform various subtasks, processes a set of data to generate values relating to the initial query. An output agent of the insight apparatus then uses the values from the machine learning model to generate an output response in natural language that answers the initial query.

A method, apparatus, non-transitory computer readable medium, and system for generating data insights using foundational generative models are described. One or more aspects of the method, apparatus, non-transitory computer readable medium, and system include obtaining a query about a user interaction with a software application; selecting a task from a plurality of event prediction tasks based on the query; generating, using a machine learning model, an event prediction based on the query and the task, wherein the machine learning model is trained to predict an event based on a sequence of user interactions with the software application; and generating a response to the query based on the task and the event prediction.

A method, apparatus, non-transitory computer readable medium, and system for generating data insights using foundational generative models are described. One or more aspects of the method, apparatus, non-transitory computer readable medium, and system include obtaining training data including a sequence of user interactions with a software application; training a machine learning model to perform a plurality of event prediction tasks based on the sequence of user interactions with the software application; selecting a task from the plurality of event prediction tasks based on a query about a user interaction with the software application; and generating, using the trained machine learning model, an event prediction based on the query and the task.

An apparatus, system, and method for generating data insights using foundational generative models are described. One or more aspects of the apparatus, system, and method include at least one processor; at least one memory storing instructions executable by the at least one processor; a machine learning model comprising parameters stored in the at least one memory and trained to perform a plurality of event prediction tasks based on a sequence of user interactions with a software application; and a natural language model comprising parameters stored in the at least one memory and configured to select a task from the plurality of event prediction tasks of the machine learning model based on a query.

### BRIEF DESCRIPTION OF THE DRAWINGS

FIG. 1 shows an example of an insight system according to aspects of the present disclosure.

FIG. 2 shows an example of an insight apparatus according to aspects of the present disclosure.

FIG. 3 shows an example of a pipeline for generating insights about data according to aspects of the present disclosure.

FIG. 4 shows an example of a method for providing data insights to a user according to aspects of the present disclosure.

FIG. 5 shows an example of a method for generating a response to a query according to aspects of the present disclosure.

FIG. 6 shows an example of a pipeline for training a machine learning model according to aspects of the present disclosure.

FIG. 7 shows an example of a method for training a machine learning model for a sequence-to-sequence task according to aspects of the present disclosure.

FIG. 8 shows an example of a method for training and using a machine learning model according to aspects of the present disclosure.

FIG. 9 shows an example of a computing device according to aspects of the present disclosure.

### DETAILED DESCRIPTION

Data analysis is a comprehensive process that involves extracting meaningful insights from various forms of data. This process is fundamental in numerous fields, including business intelligence, research, and technology. In business, data analysis is routinely used for identifying trends, making predictions, and deriving insights to inform strategic decisions. Typical methods involve statistical analysis, data mining, and visualization techniques. These approaches enable the identification of patterns and relationships within data sets, contributing to a deeper understanding of underlying dynamics in various scenarios, like market trends, customer preferences, or operational efficiencies.

A specific application of data analysis is the understanding of user behavior patterns. Conventional methods for this task often involve querying databases using structured, non-natural language queries. These methods are efficient for retrieving specific subsets of data, but they might not be as effective in capturing complex relationships across large datasets. Traditional approaches typically return basic data, requiring further interpretation to extract meaningful insights. While these methods are valuable, they can be limited in their ability to provide comprehensive and nuanced understanding of user behavior, especially when dealing with vast and complex datasets that are common in today's digital environment. Furthermore, these conventional methods typically involve the development of models or tools that are bespoke to specific datasets. The conventional methods are a fragmented approach, and lack generalizability and scalability to different or broader tasks. There is need for more versatile and adaptable systems that can be applied to a wide range of tasks using varied sets of data.

Machine learning (ML) is a branch of artificial intelligence that involves training computers to learn from and make decisions based on data. It uses algorithms and statistical models to enable machines to improve at tasks through experience, without being explicitly programmed for each specific task. This process involves identifying patterns and making predictions or decisions, based on the input data it is provided. Generative models are a type of ML model that can generate new data based on relationships learned during training. One example of generative models is the sequence-to-sequence model. These models, often built using transformer architectures, are designed to take a sequence of data as input and generate a corresponding sequence as output. They are highly effective in handling sequential data and are capable of understanding and generating predictive sequences based on learned patterns from training data.

Embodiments described herein include an insight apparatus that is configured to answer natural language queries about a dataset. The system is configured to determine the analysis tasks associated with the query using an input agent. A foundational model, referred to herein as a “core model”, is trained to fill in missing portions of a sequence, e.g., to extend the sequence or to infill portions of a sequence. A “high level model” is built on top of the core model, and calls upon the functionality of the core model to perform higher-order functions used in the analysis tasks. Then, a language-model-based output agent generates an output response in natural language using the results from the high level model. Embodiments improve on existing data analysis systems by providing a unified pipeline for answering queries related to a multiple different tasks, in contrast to the conventional siloed approach. Further, embodiments enable the prediction and analysis of data at large scales in real-time.

As used herein, a “query” refers to a natural language question input to the system by a user. The query can include additional sentences that specify additional conditions for the system to consider.

As used herein, a “task” is a data analysis procedure. Embodiments include a high level model configured to perform a set of tasks. According to some aspects, the tasks include: predicting user engagement or likelihood for performing certain actions, user journey forecasting, filling in missing steps in a user journey, estimating an uplift in user engagement from one or more intervening events, generating cohorts of journeys to identify success and failure paths, simulating a percentage of users who will experience a certain activity given previous activities, computing the likelihood of a sequence given previous events, and computing the perplexity of a given sequence.

As used herein, a “machine learning model” includes a core model and a high level model. The core model is trained to predict portions of a sequence, and the high level model is configured to use the core model to perform tasks.

As used herein, a “user interaction history” is a historical record of users' interactions with a software application. The user interaction history is used to train the machine learning model during a training phase, and can also be referenced during inference time for insights about user patterns and behavior. It should be noted once again that the embodiments described herein are not necessarily only applicable to user interactions with a software application; the embodiments can also be used to process other types of data.

As used herein, “query context information” is structured information that is extracted from the natural language input query using an input agent. The query context information can include information about a user, a hypothetical user, or a sequence of events.

Embodiments of the machine learning model include a sequence-to-sequence core model. A sequence-to-sequence model is a function that processes input tokens to produce output tokens. A token is a fundamental unit of text used for analysis and processing, representing individual characters, words, or longer sequences. Embodiments herein generate a token vocabulary in which tokens can represent a single user action, profile or attribute. Embodiments further include some special tokens: an ‘EOS’ is used to indicate the end of a sequence, an ‘SEP’ token is used distinguish between different segments or parts of a sequence, a ‘BOS’ is used to mark the beginning of a sequence, an ‘INFILL token’ is used to suggest missing steps, and a ‘Wildcard’ token is used to mask several tokens within a sequence.

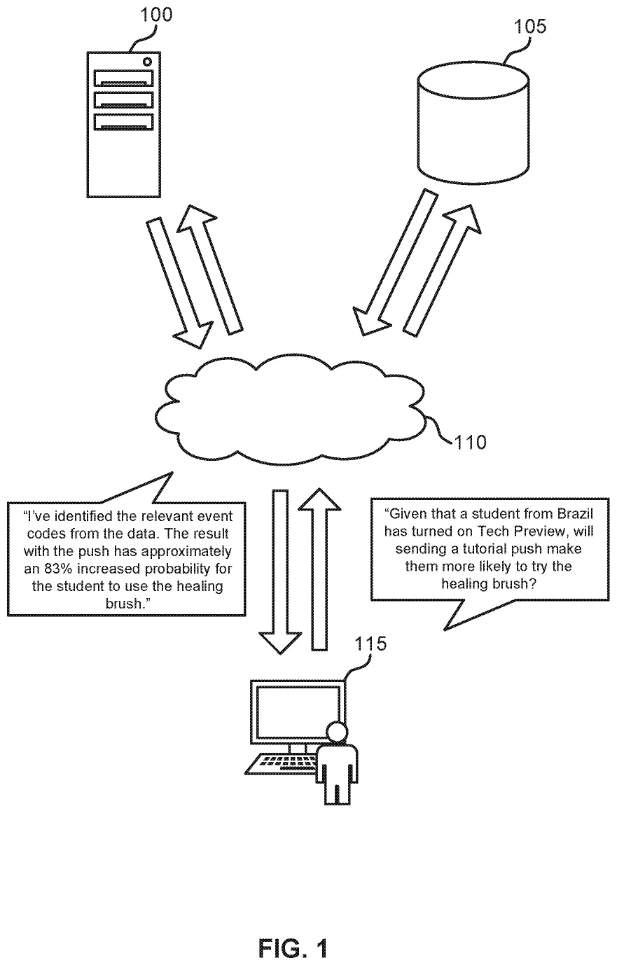

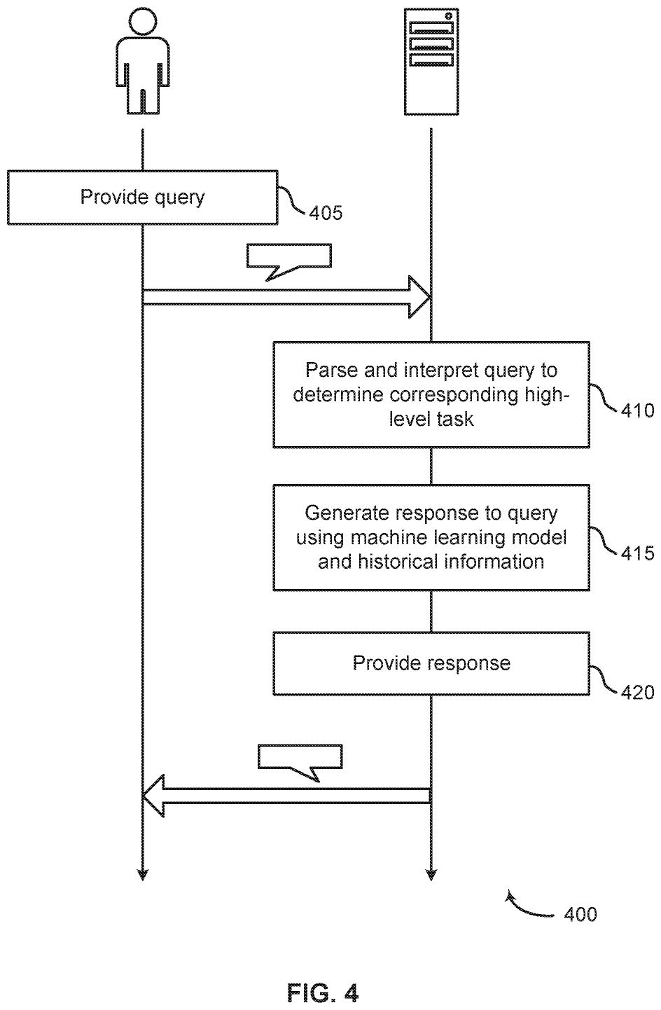

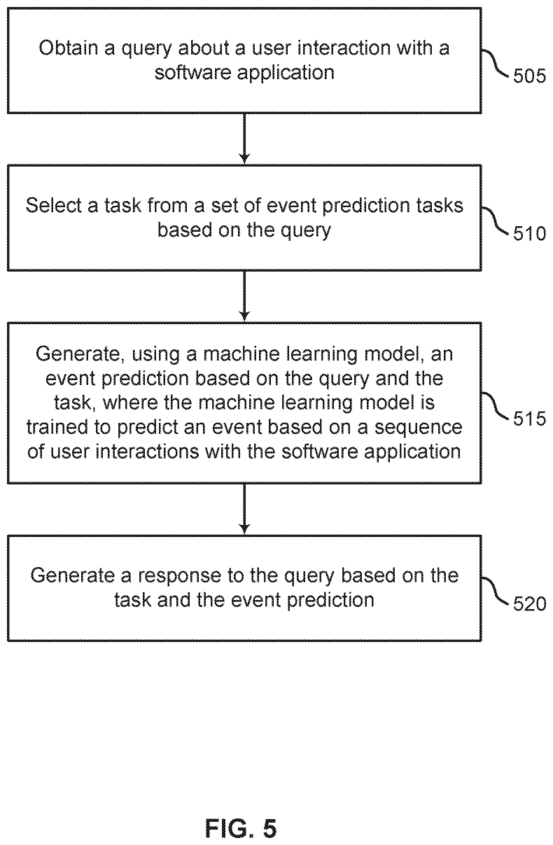

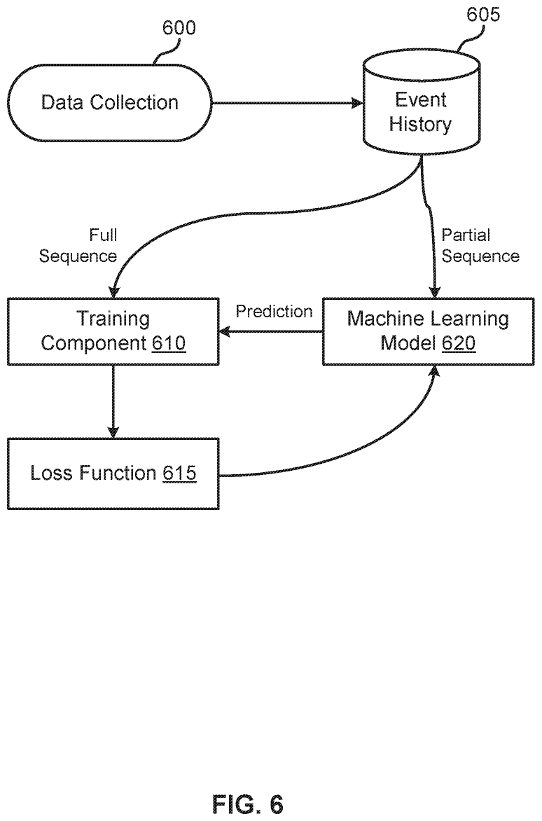

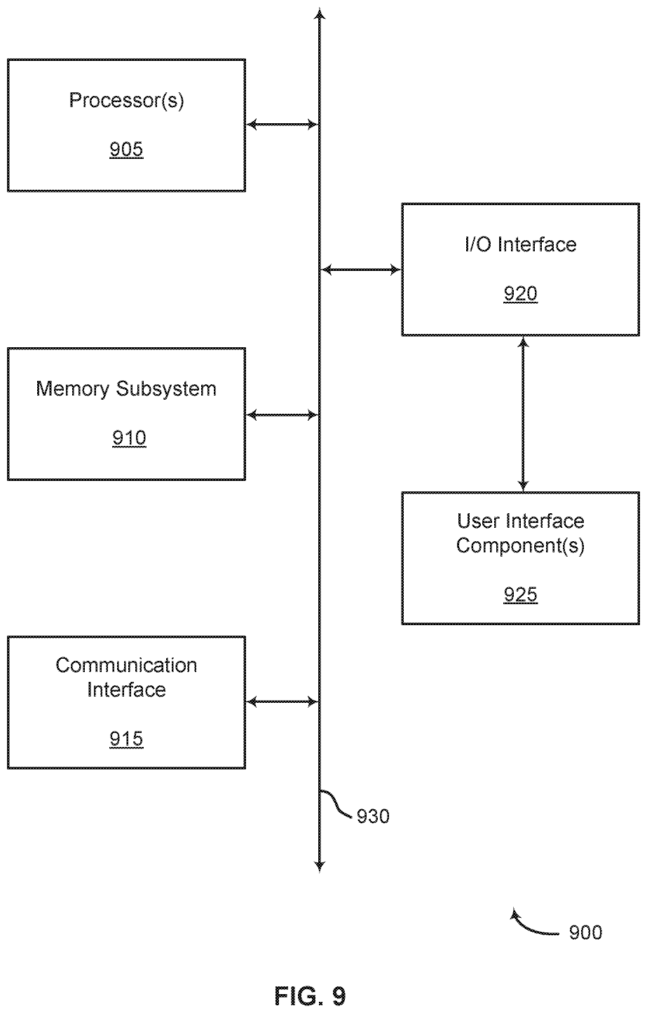

An insight system is described with reference to FIGS. 1-3. Methods for generating insights from data are described with reference to FIGS. 4-5. Methods for training a machine learning model are described with reference to FIGS. 6-8. A computing device configured to implement an insight apparatus is described with reference to FIG. 9.

### Insight System

An apparatus for generating data insights using foundational generative models is described. One or more aspects of the apparatus include at least one processor; at least one memory storing instructions executable by the at least one processor; a machine learning model comprising parameters stored in the at least one memory and trained to perform a plurality of event prediction tasks based on a sequence of user interactions with a software application; and a natural language model comprising parameters stored in the at least one memory and configured to select a task from the plurality of event prediction tasks of the machine learning model based on a query. In some aspects, the natural language model includes an input agent and an output agent, and the output agent is configured to generate a response to the query based on an output of the machine learning model.

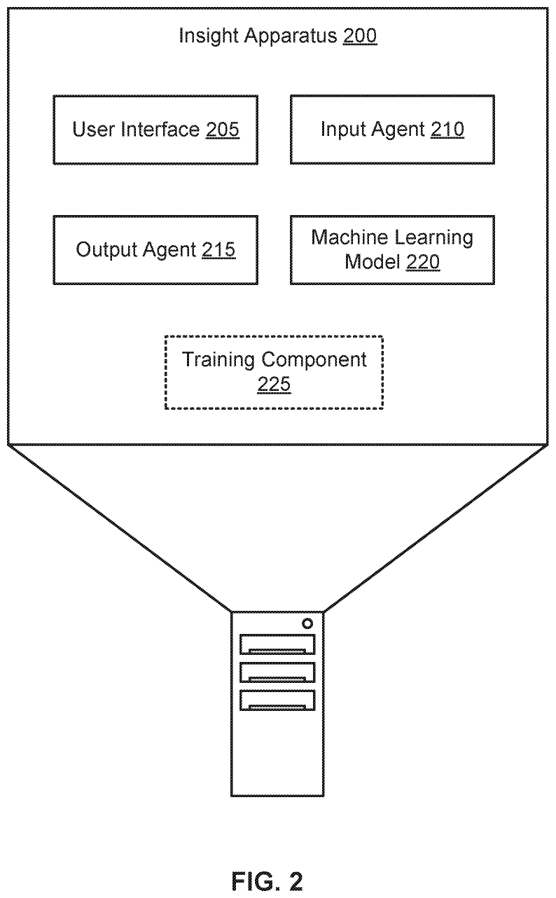

FIG. 1 shows an example of an insight system according to aspects of the present disclosure. The example shown includes insight apparatus 100, database 105, network 110, and user interface 115. Insight apparatus 100 is an example of, or includes aspects of, the corresponding element described with reference to FIG. 2.

In an example process, a user provides a query in natural language via user interface 115. The query may be a question about a hypothetical user or a general question about expected behavior in a software application, for example. Insight apparatus 100 parses the natural language query to form a structured input to a machine learning model. The structured input includes one or more task(s) and conditional information. The machine learning model processes the structured input to generate predicted values. The predicted values are used to generate an output response in natural language answering the initial query, which is then provided to the user.

FIG. 2 shows an example of an insight apparatus 200 according to aspects of the present disclosure. The example shown includes insight apparatus 200, user interface 205, input agent 210, output agent 215, machine learning model 220, and training component 225. Insight apparatus 200 is an example of, or includes aspects of, the corresponding element described with reference to FIG. 1.

User interface 205 is an example of, or includes aspects of, the corresponding element described with reference to FIG. 1. In some embodiments, user interface 205 is provided on a device different than insight apparatus 200, such as an edge device or a user device. In some embodiments, user interface 205 is provided on insight apparatus 200, e.g., as illustrated in FIG. 2. User interface 205 enables a user to interact with insight apparatus 200. In some embodiments, the user interface 205 includes an audio device, such as an external speaker system, an external display device such as a display screen, or an input device (e.g., remote control device interfaced with the user interface 205 directly or through an IO controller module). In some cases, a user interface 205 includes a graphical user interface (GUI).

Insight apparatus 200 includes components that include artificial neural networks (ANNs). An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. In some examples, nodes may determine their output using other mathematical algorithms (e.g., selecting the max from the inputs as the output) or any other suitable algorithm for activating the node. Each node and edge is associated with one or more node weights that determine how the signal is processed and transmitted.

During the training process, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

Embodiments of input agent 210, for example, include an ANN. Embodiments of input agent 210 include a natural language processing (NLP) model, and more particularly, a Language Model (LM). LMs are types of ANNs designed to understand, interpret, and generate human language. By analyzing patterns in large datasets of text, they can process queries in natural language and translate these into structured formats suitable for further analysis. LMs are based on an ANN architecture known as a transformer. A transformer or transformer network is a type of neural network models used for natural language processing tasks. A transformer network transforms one sequence into another sequence using an encoder and a decoder. Encoder and decoder include modules that can be stacked on top of each other multiple times. The modules comprise multi-head attention and feed forward layers. The inputs and outputs (target sentences) are first embedded into an n-dimensional space. Positional encoding of the different words (i.e., give every word/part in a sequence a relative position since the sequence depends on the order of its elements) are added to the embedded representation (n-dimensional vector) of each word. In some examples, a transformer network includes attention mechanism, where the attention looks at an input sequence and decides at each step which other parts of the sequence are important. The attention mechanism involves query, keys, and values denoted by Q, K, and V, respectively. Q is a matrix that contains the query (vector representation of one word in the sequence), K are all the keys (vector representations of all the words in the sequence) and V are the values, which are again the vector representations of all the words in the sequence. For the encoder and decoder, multi-head attention modules, V consists of the same word sequence than Q. However, for the attention module that is taking into account the encoder and the decoder sequences, V is different from the sequence represented by Q. In some cases, values in V are multiplied and summed with some attention-weights a. Embodiments of input agent 210 are configured to use an LM to parse and interpret an input natural language query to generate structured input to machine learning model 220.

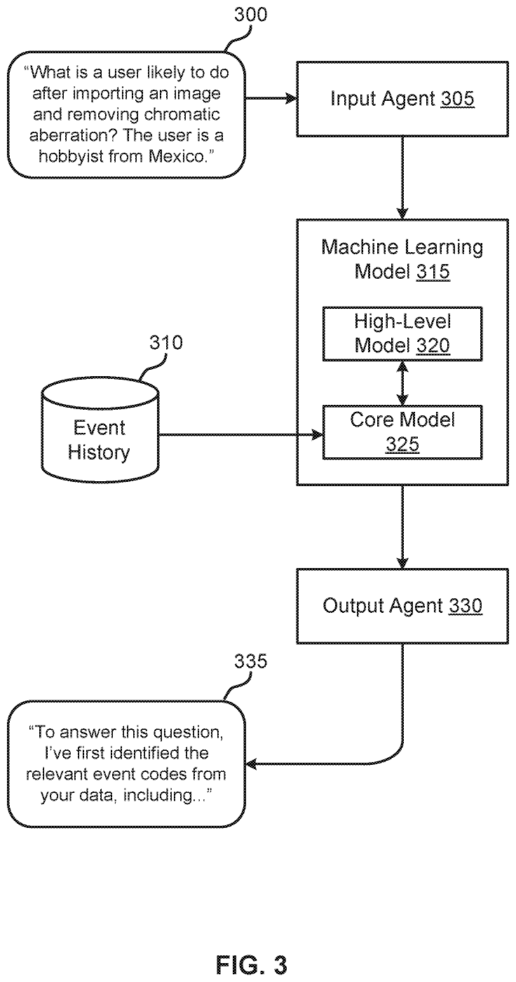

According to some aspects, input agent 210 selects a task from a set of event prediction tasks included in the structured input. In some examples, input agent 210 obtains query context information from the query. The query context information can also be included in the structured input, and can include information such as user demographic information or partial event sequences. In some examples, input agent 210 generates an input token for the machine learning model 220 based on the query context information. Some embodiments of agent 210 include a tokenizer component configured to represent the structured input as a series of tokens, which encode information from the structured input in a way that is understandable by machine learning model 220. According to some aspects, input agent 210 selects a task from a set of event prediction tasks based on the query, and the task is included in the structured input to machine learning model 220. Input agent 210 is an example of, or includes aspects of, the corresponding element described with reference to FIG. 3.

Output agent 215 is configured to use output values from machine learning model 220 to generate a natural language response. Embodiments of output agent 215 include an LM. In some cases, the LM is based on a Generative Pre-trained Transformer architecture, such as GPT-2 or GPT-3, though the present disclosure is not necessarily limited thereto, and other LM architectures can be used. Output agent 215 is an example of, or includes aspects of, the corresponding element described with reference to FIG. 3.

Machine learning model 220 is configured to process input from input agent 210 to predict values pertaining to a task identified in the input query. In some embodiments, the input from input agent 210 is a structured input including tokens describing a sequence of events, tokens describing context information, a function identifier, or a combination thereof. Embodiments of machine learning model 220 include a core model and a high level model. Additional detail regarding the core model and the high level model will be provided with reference to FIG. 3.

According to some aspects, machine learning model 220 generates an event prediction based on the query and the task. According to some aspects, the machine learning model 220 is trained to predict an event based on a sequence of user interactions with the software application. In particular, in some embodiments, a core model of the machine learning model is a sequence-to-sequence generative model and is trained based on the sequence of user interactions. In some examples, machine learning model 220 obtains a user interaction history based on the query. In some examples, machine learning model 220 generates a sequence of tokens, where each of the sequence of tokens corresponds to an event from the user interaction history, and where the machine learning model 220 takes the sequence of tokens as an input.

In some examples, machine learning model 220 generates a probability of the user interaction. In some examples, machine learning model 220 predicts an increase in a probability of the user interaction based on an intervening event. In some examples, machine learning model 220 predicts the user interaction based on a user interaction history. In some examples, machine learning model 220 fills in a missing step in a user journey. In some examples, machine learning model 220 predicts a user journey leading to the user interaction. In some examples, machine learning model 220 predicts a percentage of users that will experience a user journey that includes the user interaction. In some examples, machine learning model 220 predicts a probability of a user journey that includes the user interaction. In some examples, machine learning model 220 generates a perplexity value for a user journey that includes the user interaction. Machine learning model 220 is an example of, or includes aspects of, the corresponding element described with reference to FIGS. 3 and 6.

Training component 225 is configured to update parameters of machine learning model 220 in a training process. According to some aspects, training component 225 trains a machine learning model 220 to perform a set of event prediction tasks based on the sequence of user interactions with the software application. In some examples, training component 225 splits the sequence of user interactions into multiple parts, and trains machine learning model 220 to predict event sequences in between the parts. In some examples, training component 225 inserts a wildcard token into the split sequence of user interactions, where the training is based on the wildcard token.

In some examples, training component 225 removes a subsequence of user interactions from the sequence of user interactions based on the splitting of the sequence of user interactions. In some examples, training component 225 trains the machine learning model 220 to perform a journey infill task based on removing the subsequence of user interactions. Training component 225 is an example of, or includes aspects of, the corresponding element described with reference to FIG. 6. In at least some embodiments, training component 225 is implemented on an apparatus different from insight apparatus 200. For example, training component 225 can be implemented on a dedicated server. In some cases, the dedicated server includes specialized hardware configured to enable efficient ANN training, such as ASIC or GPU cards.

FIG. 3 shows an example of a pipeline for generating insights about data according to aspects of the present disclosure. The example shown includes input query 300, input agent 305, event history data 310, machine learning model 315, output agent 330, and output response 335.

Input agent 305 is an example of, or includes aspects of, the corresponding element described with reference to FIG. 2. Event history data 310 is an example of, or includes aspects of, the corresponding element described with reference to FIG. 6. Machine learning model 315 is an example of, or includes aspects of, the corresponding element described with reference to FIGS. 2 and 6. Output agent 330 is an example of, or includes aspects of, the corresponding element described with reference to FIG. 2.

An operator user provides input query 300 to the system. In this example, input query 300 includes a sequence of events such as “importing an image” and “removing chromatic aberration.” The input query 300 additionally includes query context information, “the user is a hobbyist from Mexico.” Input agent 305 interprets input query 300 to encode the sequence of events and the query context information into structured information, e.g., in the form of a sequence of input tokens. According to some aspects, input agent 305 further identifies a task from input query 300, and appends a task identifier corresponding to the task to the structured information.

Then, machine learning model 315 processes the structured information to predict values. In one aspect, machine learning model 315 includes high level model 320 and core model 325. Embodiments of core model 325 include three sub-components configured to perform sub-tasks. A first sub-component is a probability predictor, which computes the probability of a next event, conditional on a prompt (sequence of tokens) U₀, i.e. P(next event|U₀). A second sub-component, a generator, is configured to generate future events or in-fill missing events. A sequence of events for a user is sometimes referred to as a “user journey.” The generator sub-component can predict a future journey U_{1:I} by maximizing the chain conditional probability P(U_{1:I}|U₀)=Πᵢ₌₁^{I}P(uᵢ|u_{1:i-1},U₀). In some cases, a sampling method such as beam search is used to sample a sequence to predict the most likely sequence given U₀, until I=I₀, such that EOS taken (stop token) is generated from P(uᵢ|u_{1:i-1},U₀). In some embodiments, core model 325 references event history data 310 at inference time so as to make predictions using the most up-to-date data. The training process for training the generator sub-component of core model 325 will be described in further detail with reference to FIG. 6. A third sub-component includes an encoder configured to generate an embedding based on a prompt U. The encoder can be utilized to generate logical touchpoints and sessions, and produce embeddings for use in downstream models.

High level model 320 receives the structured input including the sequence of tokens and the function identifier, and performs the function associated with the function identifier by selectively inputting the sequence of tokens to core model 325. According to some aspects, high level model 320 is configured to perform a set of functions representing a respective set of tasks. An embodiment in which high level model 320 is configured to perform at least 8 functions will now be described. The special tokens described at the beginning of this document will be referenced.

A first function of high level model 320 includes predicting the propensity of user engagement, including a user's likelihood to perform certain actions. In an example, this first function computes P(target event representing engagement or other action|<|BOS|> historical event sequence <|SEP|> profile <|SEP|>), which is the probability of the next engagement-related event. A second function includes forecasting a user journey based on past behavior. In an example, the high level model 320 calls upon core model 325 to use its generator sub-component to compute Generator (|<|BOS|> historical event sequence <|SEP|> profile <|SEP|>). In some aspects, the events are generated one by one using conditional probability based on previous events and profile information, until the EOS token is generated.

A third function includes filling in missing steps within a user's journey when provided with specific anchor points. In an example, high level model 320 calls the generator to compute Generator (|<|BOS|> historical event sequence <|INFILL|> target event <|SEP|> profile <|SEP|>). Missing steps are substituted by the infill token, and steps are generated one by one until the EOS token is generated. A fourth function includes estimating the uplift in user engagement from an intervening event. The high level model 320 computes two probabilities: the next step probability of an engagement-related event based on the user's previous events and profile, and the next step probability of the same engagement-related event based on the user's previous events and profile in addition to the intervening event. The intervening event could be, for example, an event related to marketing or push notifications. The difference is the uplift in engagement, and is represented by P(target event |<|BOS|> historical event sequence plus marketing action <|SEP|> profile <|SEP|>)−P(target event|<|BOS|> historical event sequence <|SEP|> profile <|SEP|>).

A fifth function involves generating groups of sequences, referred to as “journey cohorts.” Multiple journeys are simulated, and the results of the journeys can be interpreted to yield insights which can be presented by output agent 330. For example, the journeys can be generated using the generator, e.g. Generator (|<|BOS|> historical event sequence <|INFILL|> target event representing for successful or failed journey <|SEP|> profile <|SEP|>). A sixth function involves simulating the percentage of users who will experience a particular journey. A journey can be designed using a journey designing software, and converted to a sequence of events for evaluation. This probability can be computed thusly: P(<|SEP|> activity j|<|BOS|> previous activities)=P(<|SEP|> activity j|<|BOS|> previous activities)/(Σⱼ₌₁^{N}P(<|SEP|> activity j|<|BOS|> previous activities)+P(<|EOS|>|<|BOS|> previous activities)). The normalized transitional probability of users experiencing a certain activity given by previous activities is given by P(<|BOS|> journey path <|EOS|>)=Πⱼ₌₁^{N}P(<|SEP|> activity j|<|BOS|> previous activities)*P(<|EOS|>|<|BOS|> journey path). The percentage of users who will experience a certain journey path is calculated by multiplying the transitional probabilities in a chain.

A seventh function includes computing the likelihood of a sequence U_{1:I}. This likelihood is given by: P(U_{1:I})=Πᵢ₌₁^{I}P(uᵢ|u_{1:i-1}). An eighth function of the high level model 330 includes computing the perplexity of a sequence, given by: perplexity(U_{1:I})=(Πᵢ₌₁^{I}P(uᵢ|u_{1:i-1}))^{-1/I}. The set of functions described herein is not exhaustive, however, and additional functions for data analysis using the predictive capabilities of core model 330 can be created.

After one or more functions are performed by machine learning model 315, the results are gathered and sent to output agent 330. Output agent 330 then crafts an output response 335 summarizing the results. The following description will detail the example used in FIG. 3.

The input to the model is ““What is a user likely to do after importing an image and removing chromatic aberration? The user is a hobbyist from Mexico.” A task interpreter component of input agent 305 determines that the question asked in the input corresponds to the second function known by high level model 320, and selects a function identifier “Function-2” to include in a structured input to machine learning model 315. A condition interpreter component of input agent 305 determines the previous event sequence: [“Import:Image”, “Optics:RemoveCA:On”]. The condition interpreter component further extracts context information, in this case User profile: Hobbyist, LATAM. Both the task interpreter and the condition interpreter can be portions of the same LM of input agent 305, or can be implemented in separate LMs.

Machine learning model 315 computes the following journey completion result: “Optics: LensCorrectionSwitch:On Optics: LensCorrectionSwitch:Off Detail:Entered Detail:Sharpening Effects:Entered Effects:Texture Effects:Clarity Effects:Dehaze Effects:Vignette Light:Entered Light:Exposure Light:Contrast Sharing:Photos:ToDevice Versions:Version:ImplicitlyCreated Export:Photos:Success.” Note, this is a decoding of the token sequence produced by machine learning model 315. Then, output agent 330 interprets the result and generates output response 335, which is “To answer this question, I first identified the relevant event codes from your data. These included user actions such as “Import:Image”, “Optics:RemoveCA:On”, user profile such as Hobbyist, LATAM, I then used a specialized machine learning model to analyze the data and generate the future journey. The result is Optics:LensCorrectionSwitch:On Optics:LensCorrectionSwitch:Off Detail:Entered Detail:Sharpening Effects:Entered Effects:Texture Effects:Clarity Effects:Dehaze Effects:Vignette Light:Entered Light:Exposure Light:Contrast Sharing:Photos:ToDevice Versions:Version:ImplicitlyCreated Export:Photos:Success. In conclusion, the user will engage in various activities within the Lightroom mobile app. He enabled and disabled lens correction to fix or ignore distortions caused by the lens. He entered the detail editing section to adjust sharpness and clarity. In the effects section, he applied texture, clarity, dehaze, and vignette effects for creative enhancements. Within the light editing section, they adjust exposure and contrast. He shared photos to another device. The user also implicitly creates new versions of images when making edits. Finally, he successfully exported the edited photos.”

The example illustrated in FIG. 3 represents one possible pathway based on an input. In this example, input agent 305 determined that the second function of high level model 320 should be used to answer input query 300. However, it will be appreciated that the same, unified system is capable of answering many other different queries by using the library of functions included in high level model 320, which are powered by core model 325.

### Generating Insights

A method for generating data insights using foundational generative models is described. One or more aspects of the method include obtaining a query about a user interaction with a software application; selecting a task from a plurality of event prediction tasks based on the query; generating, using a machine learning model, an event prediction based on the query and the task, wherein the machine learning model is trained to predict an event based on a sequence of user interactions with the software application; and generating a response to the query based on the task and the event prediction.

Some examples of the method, apparatus, non-transitory computer readable medium, and system further include obtaining a user interaction history based on the query. Some examples further include generating a sequence of tokens, wherein each of the sequence of tokens corresponds to an event from the user interaction history, and wherein the machine learning model takes the sequence of tokens as an input. Some examples further include obtaining query context information. Query context information can include, e.g., demographic information about a user. Some examples further include generating an input token for the machine learning model based on the query context information.

Some examples of the method, apparatus, non-transitory computer readable medium, and system further include computing one or more functions related to the task. In some examples, the functions include: generating a probability of the user interaction, predicting an increase in a probability of the user interaction based on an intervening event, predicting the user interaction based on a user interaction history, filling in a missing step in a user journey, predicting a user journey leading to the user interaction, predicting a percentage of users that will experience a user journey that includes the user interaction, predicting a probability of a user journey that includes the user interaction, generating a perplexity value for a user journey that includes the user interaction, or a combination thereof.

Some examples of the method, apparatus, non-transitory computer readable medium, and system further include processing, using a natural language model, the query. Some further include identifying, using the natural language model, the user interaction based on the query. Some examples further include generating, using the natural language model, a natural language response to the query.

FIG. 4 shows an example of a method 400 for providing data insights to a user according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 405, a user provides a query. In an example, the user provides the query by typing a question in natural language into a text field of a user interface. The question might pertain to a particular set of data, such as the interaction histories of other users with a software application such as image editing software.

At operation 410, the system parses and interprets the query to determine a corresponding high-level task. In some cases, the operations of this step refer to, or may be performed by, an input agent as described with reference to FIGS. 2 and 3.

At operation 415, the system generates a response to the query using a machine learning model and historical information. In an example, the high-level task corresponds to a function of a set of functions the machine learning model is configured to perform. The machine learning model performs the corresponding function to generate results. Then, an output agent interprets the results to generate a natural language response to the query. At operation 420, the system provides the response to the user. According to some aspects, the system provides the response via the user interface.

FIG. 5 shows an example of a method 500 for generating a response to a query according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 505, the system obtains a query about a user interaction with a software application. In some cases, the operations of this step refer to, or may be performed by, an insight apparatus as described with reference to FIGS. 1 and 2. The query can be a natural language question about a dataset. An example of a query is illustrated in FIG. 3. In some cases, an operator user provides the query to gain insights about other users' behavior within the software application.

In one example, the operator provides the system with a query for an insight into the usage of the software application. In this example, the software application is an application for image editing. The operator might ask, “given a user has performed an image re-sizing operation, and then searched the stock image database, what is the likelihood the user will purchase a membership to the stock image database?” Accordingly, the user interactions with the software application include the image re-sizing operation and the stock image search.

At operation 510, the system selects a task from a set of event prediction tasks based on the query. In some cases, the operations of this step refer to, or may be performed by, an input agent as described with reference to FIGS. 2 and 3. Embodiments of the input agent include an LM configured to determine the task based on the query, as well as conditions such as event sequences and user profile attributes. The task may be selected from among a set of event prediction tasks, which correspond to functions that return a prediction or insight about user data. An example set of functions corresponding to event prediction tasks is described with reference to FIG. 3. In this example, the task is to predict a general user's likelihood of purchasing the membership to the stock image database, given the user's conditions. This corresponds to the “first function” as described with reference to FIG. 3.

At operation 515, the system generates, using a machine learning model, an event prediction based on the query and the task, where the machine learning model is trained to predict an event based on a sequence of user interactions with the software application. In some embodiments, the machine learning model includes a high-level model and a core model. The high-level model is configured to perform the event prediction tasks by calling one or more sub-routines executable by the core model. According to some aspects, the core model includes a sequence-to-sequence model that is trained to predict intermediary and future events for a given sequence. Examples of the machine learning model are described with reference to FIGS. 2, 3, and 6. The event prediction may be generated by the machine learning model as one or more output tokens from a token corpus, e.g., a token vocabulary. In some embodiments, the machine learning model encompasses the input agent, the high-level model, the core model, and the output agent. Methods for training the machine learning model are described in detail with reference to FIG. 6.

At operation 520, the system generates a response to the query based on the task and the event prediction. In some cases, the operations of this step refer to, or may be performed by, an output agent as described with reference to FIGS. 2 and 3. Embodiments of the output agent include an LM configured to summarize the results of the machine learning model into a natural language response. For example, the output agent can interpret the output tokens generated by the machine learning model to correspond the tokens to event sequences, and describe the predicted event sequences.

### Training

A method for training a machine learning model is described. One or more aspects of the method include obtaining training data including a sequence of user interactions with a software application; training a machine learning model to perform a plurality of event prediction tasks based on the sequence of user interactions with the software application; selecting a task from the plurality of event prediction tasks based on a query about a user interaction with the software application; and generating, using the trained machine learning model, an event prediction based on the query and the task.

Some examples of the method, apparatus, non-transitory computer readable medium, and system further include splitting the sequence of user interactions. Some examples further include training the machine learning model to perform a journey completion task based on the split sequence of user interactions. Some examples further include inserting a wildcard token into the split sequence of user interactions, wherein the training is based on the wildcard token. Some examples further include removing a subsequence of user interactions from the sequence of user interactions based on the splitting of the sequence of user interactions. Some examples further include training the machine learning model to perform a journey infill task based on removing the subsequence of user interactions.

FIG. 6 shows an example of a pipeline for training a machine learning model 620 according to aspects of the present disclosure. The example shown includes data collection 600, event history data 605, training component 610, loss function 615, and machine learning model 620. Event history data 605 is an example of, or includes aspects of, the corresponding element described with reference to FIG. 3. Training component 610 is an example of, or includes aspects of, the corresponding element described with reference to FIG. 2. Machine learning model 620 is an example of, or includes aspects of, the corresponding element described with reference to FIGS. 2 and 3.

Data collection 600 is a module configured to collect event data over time to yield event history data 605. Examples of events in the context of interactions with a software application include: “Import: Image”, “Export: Photos: Success”, “Upsell: Txn: Success”, “Sharing: Photos: Export”, Push-upsell,” and others. Data collection 600 can further collect attributes that are qualifiers to the events, such as attributes indicating whether an action belongs to an end user or an operator user. For example, sending a push notification might be associated as an action performed by an operator user.

Training component 600 is configured to use event history 605 to update parameters of machine learning model 620 in a training process. In an example, a corpus of tokens U={u₁, u₂, . . . , uₙ} is created for training data in a self-supervised pretraining process. For example, to train machine learning model 620 for a journey completion task, training component 600 will randomly split an event sequence from event history data 605 into two parts, and add separator tokens as a form of mask. The input to machine learning model 620 might look like so: “<|BOS|> Target:UpseIIJSONCached:Success Auth:ePrivacy:Continue Tab:Albums:Nullstate Tab:Albums:Nullstate Import:Image Import:Image <|SEP|> Education EMEA <|SEP|> Import:Image Overflow:CopySettings:Entered <|EOS|>”. The machine learning model 620 then guesses the missing events as a prediction. The prediction is provided to training component 610, which compares the prediction to the actual event sequence. In some embodiments, training component inserts a wildcard token into the split sequence of user interactions, which prompts machine learning model 620 to predict 1:n missing events from the sequence.

The training component 610 computes a loss function 615 representing any discrepancies between the prediction and the actual events, and uses the loss function 615 to update parameters of machine learning model 620. According to some aspects, training component 610 trains machine learning model 620 to maximize the following likelihood: L₁( [symbol] )=Σᵢ log P(uᵢ|u₀, . . . , uᵢ₋₁; Θ), where Θ are the parameters of the model.

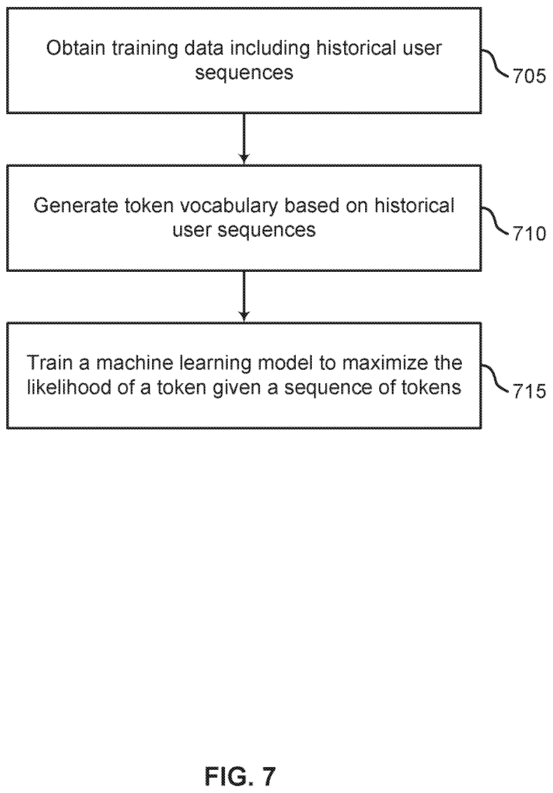

FIG. 7 shows an example of a method 700 for training a machine learning model for a sequence-to-sequence task according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 705, the system obtains training data including historical user sequences. The training data can be obtained in a data collection process as described with reference to FIG. 6. For example, the data collection might collect historical user sequences, attributes about events in the sequences, and contextual information such as user demographic information. According to some aspects, all types of data are able to be represented as tokens for later understanding by a machine learning model.

At operation 710, the system generates token vocabulary based on historical user sequences. This vocabulary building process can be performed by a training component as described with reference to FIG. 6. The vocabulary building process can involve, for example, assigning a unique identifier such as an integer to every possible event, event-attribute pair, or context information.

At operation 715, the system trains a machine learning model to maximize the likelihood of a token given a sequence of tokens. In an example, the training component trains the machine learning model to maximize the L₁ likelihood defined with reference to FIG. 6 for a given input sequence [symbol] .

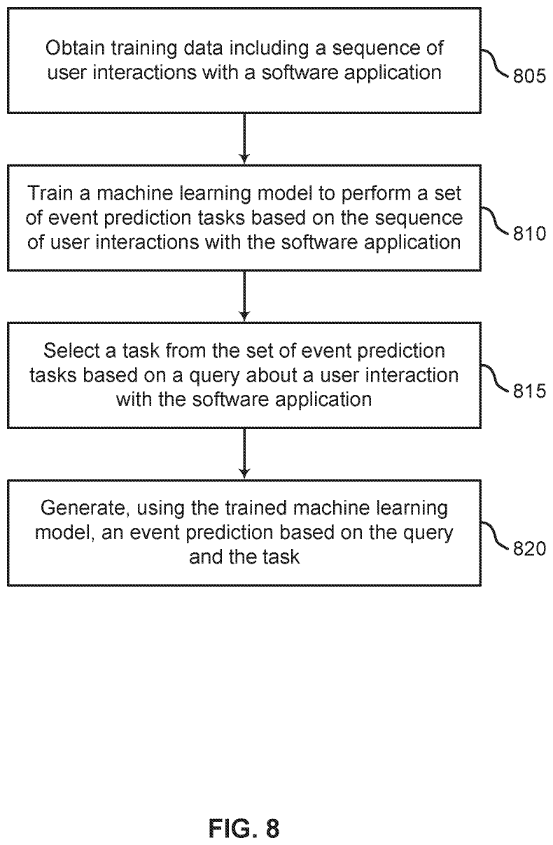

FIG. 8 shows an example of a method 800 for training and using a machine learning model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 805, the system obtains training data including a sequence of user interactions with a software application. In some cases, the operations of this step refer to, or may be performed by, an insight apparatus as described with reference to FIGS. 1 and 2. At operation 810, the system trains a machine learning model to perform a set of event prediction tasks based on the sequence of user interactions with the software application. In some cases, the operations of this step refer to, or may be performed by, a training component as described with reference to FIGS. 2 and 6. For example, the training component may update parameters of multiple sub-components of a core model included in the machine learning model. Examples of the sub-components include a probability predictor, a generator (sequence-to-sequence model), and an encoder model. The sub-components are described in detail with reference to FIG. 3.

At operation 815, the system selects a task from the set of event prediction tasks based on a query about a user interaction with the software application. In some cases, the operations of this step refer to, or may be performed by, an input agent as described with reference to FIGS. 2 and 3. The task corresponds to a function among a set of functions configured to be performed by the machine learning model.

At operation 820, the system generates an event prediction based on the query and the task. In some cases, the operations of this step refer to, or may be performed by, a machine learning model as described with reference to FIGS. 2, 3, and 6. Additional description regarding an example set of tasks is provided with reference to FIG. 3.

FIG. 9 shows an example of a computing device 900 according to aspects of the present disclosure. The example shown includes computing device 900, processor(s), memory subsystem 910, communication interface 915, I/O interface 920, user interface component(s), and channel 930.

In some embodiments, computing device 900 is an example of, or includes aspects of, insight apparatus 100 of FIG. 1. In some embodiments, computing device 900 includes one or more processors 905 are configured to execute instructions stored in memory subsystem 910 to obtain a query about a user interaction with a software application; select a task from a plurality of event prediction tasks based on the query; generate, using a machine learning model, an event prediction based on the query and the task, wherein the machine learning model is trained to predict an event based on a sequence of user interactions with the software application; and generate a response to the query based on the task and the event prediction.

According to some aspects, computing device 900 includes one or more processors 905. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 910 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. The memory may store various parameters of machine learning models used in the components described with reference to FIG. 2. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 915 operates at a boundary between communicating entities (such as computing device 900, one or more user devices, a cloud, and one or more databases) and channel 930 and can record and process communications. In some cases, communication interface 915 is provided to enable a processing system coupled to a transceiver (e.g., a transmitter and/or a receiver). In some examples, the transceiver is configured to transmit (or send) and receive signals for a communications device via an antenna.

According to some aspects, I/O interface 920 is controlled by an I/O controller to manage input and output signals for computing device 900. In some cases, I/O interface 920 manages peripherals not integrated into computing device 900. In some cases, I/O interface 920 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 920 or via hardware components controlled by the I/O controller.

According to some aspects, user interface component(s) 925 enable a user to interact with computing device 900. In some cases, user interface component(s) 925 include an audio device, such as an external speaker system, an external display device such as a display screen, an input device (e.g., a remote control device interfaced with a user interface directly or through the I/O controller), or a combination thereof. In some cases, user interface component(s) 925 include a GUI.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a query about a user interaction with a software application;
selecting a task from a plurality of event prediction tasks based on the query;
generating, using a machine learning model, an event prediction based on the query and the task, wherein the machine learning model is trained to predict an event based on a sequence of user interactions with the software application; and
generating a response to the query based on the task and the event prediction.

2. The method of claim 1, further comprising:
obtaining a user interaction history based on the query; and
generating a sequence of tokens, wherein each of the sequence of tokens corresponds to an event from the user interaction history, and wherein the machine learning model takes the sequence of tokens as an input.

3. The method of claim 1, further comprising:
obtaining query context information; and
generating an input token for the machine learning model based on the query context information.

4. The method of claim 1, wherein generating the event prediction comprises:
generating a probability of the user interaction.

5. The method of claim 1, wherein generating the event prediction comprises:
predicting an increase in a probability of the user interaction based on an intervening event.

6. The method of claim 1, wherein generating the event prediction comprises:
predicting the user interaction based on a user interaction history.

7. The method of claim 1, wherein generating the event prediction comprises:
filling in a missing step in a user journey.

8. The method of claim 1, wherein generating the event prediction comprises:
predicting a user journey leading to the user interaction.

9. The method of claim 1, wherein generating the event prediction comprises:
predicting a percentage of users that will experience a user journey that includes the user interaction.

10. The method of claim 1, wherein generating the event prediction comprises:
predicting a probability of a user journey that includes the user interaction.

11. The method of claim 1, wherein generating the event prediction comprises:
generating a perplexity value for a user journey that includes the user interaction.

12. The method of claim 1, wherein selecting the task comprises:
processing, using a natural language model, the query.

13. The method of claim 1, wherein selecting the task comprises:
identifying, using a natural language model, the user interaction based on the query.

14. The method of claim 1, wherein generating the response comprises:
generating, using a natural language model, a natural language response to the query.

15. A method for training a machine learning model, comprising:
obtaining training data including a sequence of user interactions with a software application;
training a machine learning model to perform a plurality of event prediction tasks based on the sequence of user interactions with the software application;
selecting a task from the plurality of event prediction tasks based on a query about a user interaction with the software application; and
generating, using the trained machine learning model, an event prediction based on the query and the task.

16. The method of claim 15, wherein training the machine learning model comprises:
splitting the sequence of user interactions; and
training the machine learning model to perform a journey completion task based on the split sequence of user interactions.

17. The method of claim 16, further comprising:
inserting a wildcard token into the split sequence of user interactions, wherein the training is based on the wildcard token.

18. The method of claim 16, further comprising:
removing a subsequence of user interactions from the sequence of user interactions based on the splitting of the sequence of user interactions; and
training the machine learning model to perform a journey infill task based on removing the subsequence of user interactions.

19. An apparatus comprising:
at least one processor;
at least one memory storing instructions executable by the at least one processor;
the apparatus further comprising a machine learning model comprising parameters stored in the at least one memory and trained to perform a plurality of event prediction tasks based on a sequence of user interactions with a software application; and
a natural language model comprising parameters stored in the at least one memory and configured to select a task from the plurality of event prediction tasks of the machine learning model based on a query.

20. The apparatus of claim 19, wherein:
the natural language model is configured to generate a response to the query based on an output of the machine learning model.
